(19) United States
(12) Patent Application Publication
(10) Pub. No.: US 2008/0172423 A1
(43) Pub. Date: Jul. 17, 2008

(54) HSM CONTROL PROGRAM, HSM CONTROL APPARATUS, AND HSM CONTROL METHOD

(75) Inventors: Yoshitake SHINKAI, Kawasaki (JP); Kensuke Shiozawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/023,340

(22) Filed: Jan. 31, 2008

Related U.S. Application Data
(63) Continuation of application No. PCT/JP2005/016705, filed on Sep. 12, 2005.

(51) Int. Cl. G06F 17/00

(52) U.S. Cl. 707/203; 707/E17.005

(57) ABSTRACT

An HSM program allows a computer to execute control for an HSM apparatus. The program allows the computer to execute: an event data recording step that records a file operation for the primary storage or archive state change as event data; a namespace replication step that generates a namespace replication database obtained by replicating the namespace of the primary storage; a namespace-following step that allows the namespace replication database to follow the namespace of the primary storage based on the event data; and a file migration instruction step that instructs file migration between the primary and secondary storages based on the namespace replication database.

This application is a continuation under 35 U.S.C. 111(a) of International Application No. PCT/JP2005/016705, filed Sep. 12, 2005, the disclosure of which is herein incorporated in its entirety by reference.

### TECHNICAL FIELD

The present invention relates to an HSM control program, an HSM control so apparatus, and an HSM control method that manage a hierarchical storage apparatus.

### BACKGROUND ART

An HSM (Hierarchical Storage Management) is a technique that combines a low-speed storage device (secondary storage) such as a tape library and a high-speed storage device (primary storage) such as a hard disk to build a low cost and large capacity file system.

An HSM control apparatus needs to have a function of identifying files which have not been accessed for a long time in the primary storage, writing out the files to the secondary storage, and, if an access request is made thereto, moving back the files to the primary storage. Conventionally, in order to realize this function, the HSM control apparatus uses a method of searching the entire namespace in a file system having a hierarchical structure and referring to access time that the file system retains on a file by file basis to thereby identify the file to be written out to the secondary storage.

As a related art relevant to the present invention, there is known Patent Document 1 described below. A data processor disclosed in Patent Document 1 collects log data every time the content of meta data is updated and uses the collected log data to correct inconsistency in the file system.

Patent Document 1: Jpn. Pat. Appln. Laid-Open Publication No. 2000-484995

### DISCLOSURE OF THE INVENTION

### Problems to be Solved by the Invention

However, there exist the following problems in the HSM control device using the above method of searching the entire namespace.

The first problem is overhead incurred by searching the file system. That is, the conventional HSM periodically searches the entire file namespace having a hierarchical structure, thereby incurring a large overhead.

The second problem is exclusion problem in the namespace. When a file name change operation such as “rename” operation is made to a given file during the searching of the entire namespace, a path name of the file obtained in the searching becomes invalid one which does not actually exist. Therefore, the HSM control apparatus is likely to perform a data migration operation inconsistently with a policy that a customer has set. For example, assuming that an upper directory is migrated to a recycle bin in the middle of the searching, all the items in the recycle bin are likely to be set as an object to be migrated. In order to prevent this, it is necessary for the HSM control apparatus to frequently check inconsistency in the course of the searching of the entire namespace and, if there finds inconsistency to start the searching from the beginning again, thereby making the logic very complicated and significantly increasing overhead.

The third problem is flexibility in HSM policy control. Since the namespace having a hierarchical structure generally represents the attribute of stored files, it is natural to set (HSM policy of all files under a given directory, etc.) the HSM policy based on the namespace. However, the abovementioned exclusion problem in the namespace makes it difficult to realize a complicated policy control based on the namespace.

The fourth problem is deficiency of the attribute information of the data saved in the secondary storage. Further, it is difficult to add a correct path name to the data stored in the secondary storage due to the exclusion problem in the namespace. Therefore, the data stored in the secondary storage can be accessed only using the meta data of the file system. Thus, if the meta data in the file system become corrupted, association between the meta data and path name of the data stored in the secondary storage is made invalid. Thus, in this case, the file data cannot be recovered although they exist on the secondary storage.

The present invention has been made to solve the above problems and an object thereof is to provide an HSM control program, HSM control apparatus, and HSM control method capable of efficiently replicating the namespace to realize a complicated policy control based on the namespace.

### Means for Solving the Problems

To solve the above problem, according to the first aspect of the present invention, there is provided an HSM control program allowing a computer to execute control for an HSM apparatus using primary and secondary storages, the program allowing the computer to execute: an event data recording step that records a file operation for the primary storage or archive state change as event data; a namespace replication step that generates a namespace replication database obtained by replicating the namespace of the primary storage; a namespace-following step that allows the namespace replication database to follow the namespace of the primary storage based on the event data; and a file migration instruction step that instructs file migration between the primary and secondary storages based on the namespace replication database.

In the HSM control program according to the present invention, the file migration instruction step determines a file to be migrated from the primary storage to secondary storage based on the namespace replication database.

In the HSM control program according to the present invention, the namespace-following step updates the namespace replication database based on event data existing after completion of the initial replication of the namespace replication database.

In the HSM control program according to the present invention, the namespace replication step updates the namespace replication database based on event data existing during generation of the namespace replication database.

In the HSM control program according to the present invention, in the case where a system in which the HSM control program is running is terminated, the program further allows the computer to execute a system termination step that reflects event data recorded by the event data recording step on the namespace replication database.

In the HSM control program according to the present invention, in the case where a system in which the HSM control program is running is started up after abnormal termination of the system, the program further allows the computer to execute the namespace replication step.

In the HSM control program according to the present invention, in the case where the amount of recorded event data reaches a predetermined value or after a predetermined time period has elapsed, the event data recording section allows the namespace-following step to be executed based on the event data recorded on the memory.

In the HSM control program according to the present invention, the event data includes the type and occurrence time of a file operation or archive state change.

In the HSM control program according to the present invention, the namespace replication database includes a file attribute and archive state.

According to a second aspect of the present invention, there is provided an HSM control apparatus that executes control for an HSM apparatus using primary and secondary storages, comprising: an event data recording section that records a file operation for the primary storage or archive state change as event data; a namespace replication section that generates a namespace replication database obtained by replicating the namespace of the primary storage; a namespace-following section that allows the namespace replication database to follow the namespace of the primary storage based on the event data; and a file migration instruction section that instructs file migration between the primary and secondary storages based on the namespace replication database.

In the HSM control apparatus according to the present invention, the file migration instruction section determines a file to be migrated from the primary storage to secondary storage based on the namespace replication database.

In the HSM control apparatus according to the present invention, the namespace-following section updates the namespace replication database based on event data existing after completion of the initial replication of the namespace replication database.

In the HSM control apparatus according to the present invention, the namespace replication section updates the namespace replication database based on event data existing during generation of the namespace replication database.

In the HSM control apparatus according to the present invention, in the case where a system provided with the HSM control apparatus is terminated, the event data recording section reflects recorded event data on the namespace replication database.

In the HSM control apparatus according to the present invention, in the case where a system provided with the HSM control apparatus is started up after abnormal termination of the system, the namespace replication section is activated.

In the HSM control apparatus according to the present invention, in the case where the amount of recorded event data reaches a predetermined value or after a predetermined time period has elapsed, the operation of the namespace-following section is executed based on the recorded event data.

In the HSM control apparatus according to the present invention, the event data includes the type and occurrence time of a file operation or archive state change.

In the HSM control apparatus according to the present invention, the namespace replication database includes a file attribute and archive state.

According to a third aspect of the present invention, there is provided an HSM control method that executes control for an HSM apparatus using primary and secondary storages, comprising: an event data recording step that records a file operation for the primary storage or archive state change as event data; a namespace replication step that generates a namespace replication database obtained by replicating the namespace of the primary storage; a namespace-following step that allows the namespace replication database to follow the namespace of the primary storage based on the event data; and a file migration instruction step that instructs file migration between the primary and secondary storages based on the namespace replication database.

### BRIEF DESCRIPTION OF THE DRAWINGS

FIG. 1 is a block diagram showing an example of a configuration of an HSM system according to the present invention;

FIG. 2 is a flowchart showing an example of operation of file information acquisition processing according to the present invention;

FIG. 3 is a view showing an example of a hierarchical structure of a directory in the namespace;

FIG. 4 is a flowchart showing an example of operation of file information acquisition processing according to the present invention;

FIG. 5 is a flowchart showing an example of operation of event data reflection processing according to the present invention; and

FIG. 6 is a flowchart showing an example of operation of migration determination processing according to the present invention.

### BEST MODE FOR CARRYING OUT THE INVENTION

An embodiment of the present invention will be described below with reference to the accompanying drawings.

In the present embodiment a server serving as an HSM control apparatus according to the present invention will be described.

First, a configuration of an HSM system having the server according to the present invention will be described.

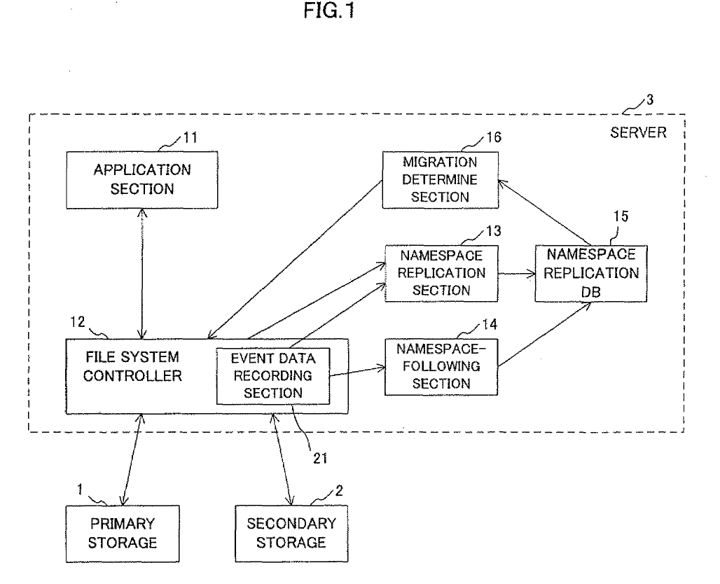

FIG. 1 is a block diagram showing a configuration of the HSM system according to the present invention. The HSM system includes a primary storage 1 which is a high-speed storage device such as a disk drive storing recently-accessed files, a secondary storage 2 which is a low-speed storage device such as a tape library storing file data which have not been accessed for a long time, and a server 3 which is an HSM control apparatus according to the present invention, in which an application program for accessing file data is running.

The server 3 includes an application section 11, a file system controller 12, a namespace replication section 13, a namespace-following section 14, a namespace replication DB (Database) 15, and a migration determination section 16. The file system controller 12 includes an event data recording section 21.

Functions of the respective sections constituting the server 3 will next be described.

The event data recording section 21 is a program provided in the file system controller 12 and having a function of storing the history of file operation requests issued by an application program as event data. The event data recording section 21 converts the contents of the file operation requests issued by the application section 11 into a form of event data so as to store them on a memory and, when the amount of the event data reaches a predetermined level, sends them to the namespace replication section 13 and namespace-following section 14. The event data may be sent through a communication line or through use of a dedicated file.

The namespace replication section 13 is a program having a function of replicating the namespace of a file system in parallel to the operation of the application section 11. The namespace replication section 13 traverses the namespace of a file system to acquire the file information of existing files. The namespace replication section 13 combines the acquired file information and event data received from the event data recording section 21 during the file information acquisition process to complete the initial namespace replication in the form of a namespace replication DB 15.

The namespace-following section 14 updates the replication, after the completion of the namespace initial replication, according to the event data received from the event data recording section 21 so as to keep the namespace replication DB 15 up to date. Further, the namespace-following section 14 also plays a role of reflecting notified file access or archive state on the namespace replication DB 15.

The migration determination section 16 is a program having a function of issuing an instruction, as a policy control, to the file system controller 12 in order to send out (migrate) files which have not been accessed for a long time in the primary storage 1 to the secondary storage 2 according to file access records set by the namespace replication section 13 and a policy set by a user. In general, when a given file among the migrated files in the secondary storage 2 is accessed by the application section 11, the accessed file is migrated back to the primary storage 1 (recall) by the file system controller 12. Further, every time a file updated operation is executed, data (archive data) on the secondary storage 2 are invalidated by the file system controller 12. The data on the secondary storage 2 are not erased at this timing but stored as backup data as long as the capacity of the secondary storage 2 is allowed so as to be used to recover from a system failure, if occurring.

Details of the event data, file information, and namespace replication DB 15 will next be described.

First, the event data will be described.

The event data (event) created by the event data recording section 21 represents the content of file operations such as creation/delete of a file or directory, file name change, file access, archive state change. The event data corresponding to each operation includes operation name and time at which an operation corresponding to the operation name is executed, as well as the following data. The term “archive state change” used here includes events such as validation/invalidation of archive data, migration, and recall.

(1) Creation of File or Directory

event. rectype=create

event. m_inode#=inode number of parent directory

event. ftype=dir (at mkdir time) or file (at create time)

event. fname=name of created file

event. inode#=inode number of created file or directory

event. time=time when this event occurs

(2) Delete of File or Directory

event. rectype=delete

event. m_inode#=inode number of parent directory

event. ftype=dir (at rmdir time) or file (at romove time)

event. inode#=inode number of deleted file or directory

event. time=time when this event occurs

(3) File Name Change

event. rectype=rename

event. m_inode#=inode number of parent directory

event. ftype=dir (in the case where target is directory) or file (in the case where target is file)

event. inode#=inode number of target file or directory

event. target. m_inode#=inode number of migration destination directory

event. target. fname=name of file or directory after renaming

event. time=time when this event occurs

(4) File Access (Application Program Reads/Writes File)

event. rectype=access

event. inode#=inode number of file

event. time=time when this event occurs

(5) Archive State Change

event. rectype=archive

event. inode#=inode number of file

event. migrate=on (migrated state) or off (recall is activated to release migrated state)

event. archive=on (file data has been written onto secondary storage 2 to validate archive data) or off (file has been updated to invalidate archive data)

event. time=time when this event occurs

Next, the file information will be described.

The file information (fstat) acquired from the file system during the name space replication includes the following.

fstat. m_inode#=inode number of parent directory

fstat. ftype=dir (in the case where target is directory) or file (in the case where target is file)

fstat. fname=name of file or directory

fstat. inode#=inode number of file or directory

fstat. archive=on (archive data is valid) or off (archive data is invalid)

fstat. migrate=on (migrated state) or off (non-migrated state)

fstat. atime=time when file was lastly accessed

fstat. time=file information acquisition time

Next, a configuration of the name space replication DB 15 will be described.

The namespace replication DB 15 is a relational database having columns (dbe) shown below, each of which having a tuple for each file element set in a directory or directory element.

dbe. m_inode#=inode number of parent directory

deb. ftype=dir (in the case where this tuple indicates directory) or file (in the case where this tuple indicates file)

dbe. fname=name of file or directory

dbe. inode#=inode number of file or directory

dbe. archive=on (archive data is valid) or off (archive data is invalid)

dbe. migrate=on (migrated state) or off (non-migrated state)

dbe. atime=time when file was lately accessed

dbe. active=on (file information has been acquired) or off (file information has not yet been acquired)

Operation of the server 3 will next be described.

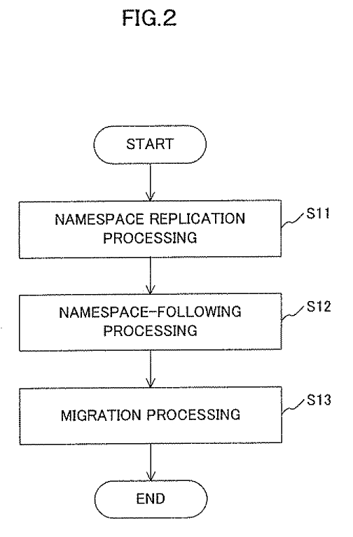

FIG. 2 is a flowchart showing an example of operation of file information acquisition processing according to the present invention. The server 3 executes namespace replication processing (S11), namespace-following processing (S12), and migration processing (S13).

Details of the operation performed by the server 3 will be described.

First, the namespace replication processing will be described.

The namespace replication processing is performed for creating the initial replication of the namespace and includes file information acquisition processing and event data reflecting processing. Further, the namespace replication processing is performed also for the purpose of re-creating the namespace replication DB 15 at, e.g., the server restart time after occurrence of a failure, where event data stored on the memory have been lost and thereby the content of the namespace DB 15 cannot reflect the latest state of the file system. In such a configuration in which the namespace replication DB 15 is dynamically re-created, it is not necessary to make the event data nonvolatile at the occurrence time of the event but only necessary to store the event data in a small capacity memory, thereby reducing overhead involving the subsequent namespace replication DB-following processing.

As the file information acquisition processing, the namespace replication section 13 opens a parent directory, specifies a child file name or child directory name as an argument, and issues an information acquisition function (getinfo) of the file system, thereby obtaining the file information. Further, the namespace replication section 13 follows the namespace in the ascending (or descending) order of a path name to completely obtain the information of all directories and all files existing in the file system. Since directories or files missed in this process are recorded as event data, correction can be made later.

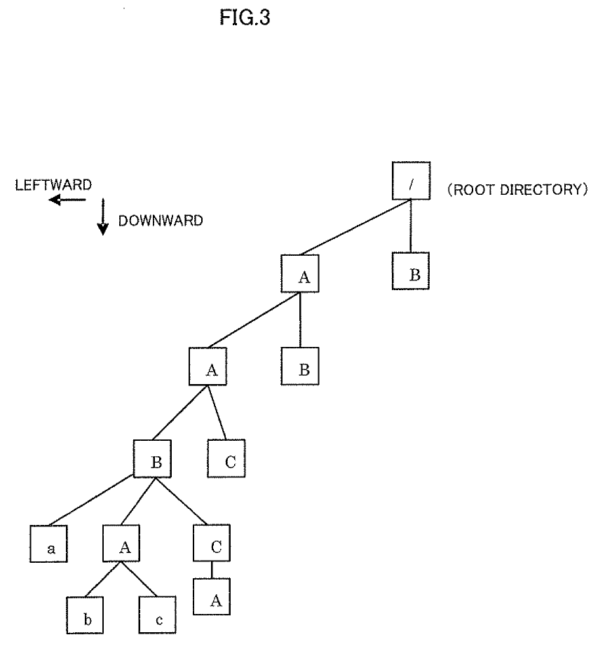

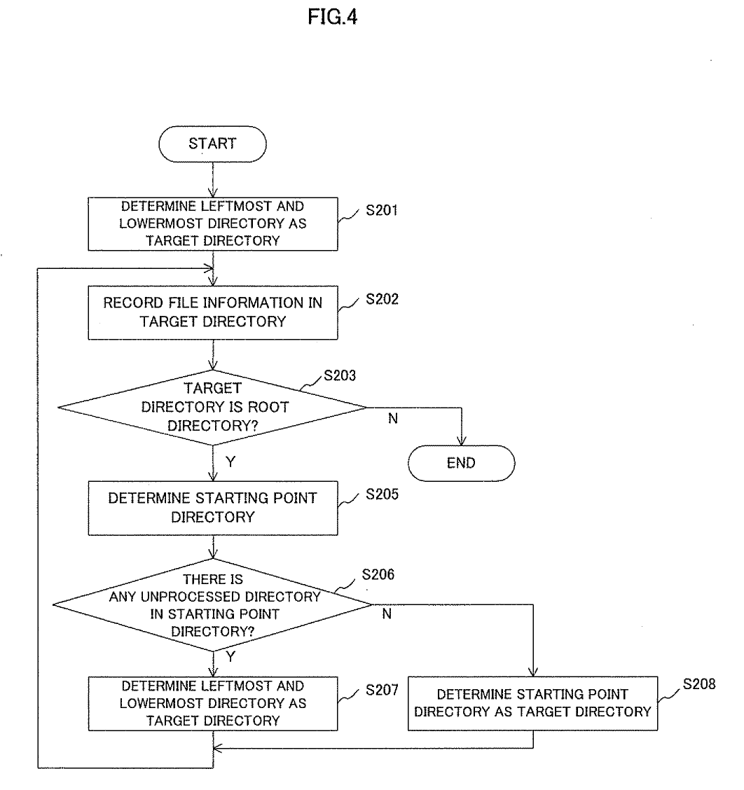

FIG. 3 is a view showing an example of a hierarchical structure of a directory in the namespace. The namespace shown in FIG. 3 is obtained by sorting the names of directories and files in the directory hierarchical structure in the ascending order from left to right. FIG. 4 is a flowchart showing an example of operation of file information acquisition processing according to the present invention.

The namespace replication section 13 traverses the hierarchical structure in the left downward direction (in the ascending order of directory name) starting from the root directory of the target file system and finds the leftmost and lowest directory. The namespace replication section 13 then sets the leftmost and lowest directory as a target directory and sets the pathname of the target directory acquired in the course of the target directory search as a target directory pathname (S201). The namespace replication section 13 then acquires the file information of the target directory and file information of all the files in the target directory one by one in the ascending order of the file name and sequentially writes them at the end of a file information recording file (S202). Then, the namespace replication section 13 determines whether the target directory is the root directory or not (S203). When determining that the target directory is the root directory (Y in S203), which means that all files has been processed and therefore the namespace replication section 13 ends this flow.

On the other hand, when determining that the target directory is not the root directory (N in S203), the namespace replication section 13 acquires the pathname of the directory one level above the target directory, that is, sets a path name obtained by removing the last directory name constituting the path name as a new path name. The namespace replication section 13 then searches again the hierarchical structure for the acquired directory path name from the root directory in the downward direction. The last directory whose existence has been confirmed by the search is set as the starting point directory (S205). In the case where a directory in the middle of the path has been migrated to another location in the namespace by rename operation or the like, the migrated directory cannot be found in the course of the search. However, the missed portion will be found in the subsequent file information acquisition processing or recorded in the event data and, therefore, the namespace will surely be corrected later. Thus, the missed portion can be ignored at this time point.

The namespace replication section 13 then reads the content of the starting point directory and determines whether there is any unprocessed directory in the starting point directory (S206). When determining that there is any unprocessed directory in the starting point directory (Y in S206), the namespace replication section 13 sets the leftmost and lowermost directory among the unprocessed directories in the starting-point directory as a new target directory (S207) and shifts to step S202. In the case where there is no unprocessed directory, that is, in the case where there is no directory having a name alphabetically greater than one of the target directory pathname in the starting point directory (N in S206), the namespace replication section 13 sets the pathname of the starting point directory as the target directory pathname (S208) and shifts to step S202.

After completion of the file information acquisition processing for the target file system, the namespace replication section 13 performs event data reflection processing of reflecting event data generated during the information acquisition processing on the file information. In the event data reflection processing, the namespace replication section 13 sequentially reads the content of the file information recording files from the beginning to process all the file information recorded in the file information recording file.

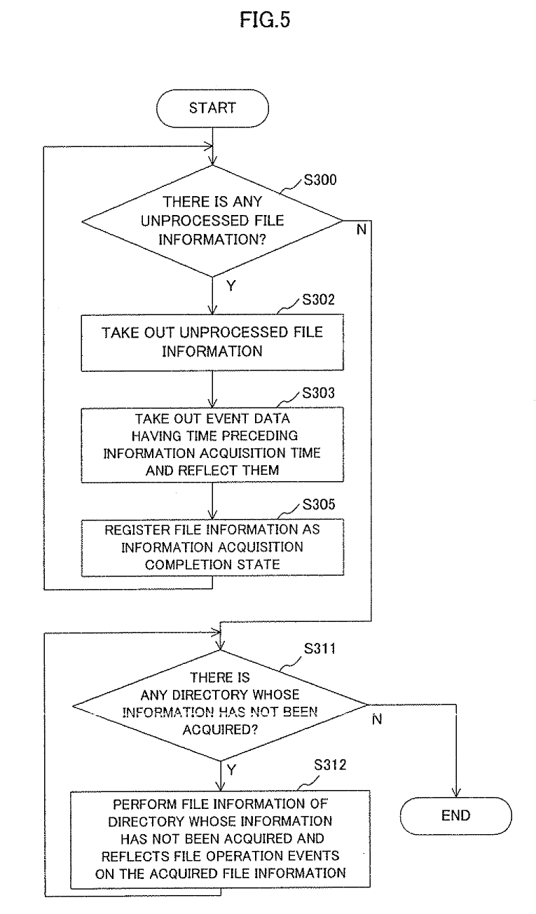

FIG. 5 is a flowchart showing an example of operation of the event data reflection processing according to the present invention. The namespace replication section 13 takes out unprocessed file information (S302) and then sequentially takes out event data having the time preceding the information acquisition time set in the file information and reflects them on the namespace replication DB 15 (S303).

Hereinafter, the reflection of event data on the namespace replication DB 15 will be described for each file operation type (file delete, file creation, file name change, file access, and archive state change).

In the case where the event data represents the file delete type operation (file delete or directory delete), the namespace replication section 13 deletes a delete target file or directory if it has been registered in the namespace replication DB 15 and ignores this event data if not registered. Here, in the case where there exists an entry that satisfies the following all conditions, the corresponding file or directory is regarded as being registered.

dbe. inode#==event. inode#

dbe. m_inode#==event. m_inode#

dbe. fname==event. fname

In the case where the event data represents the file creation type operation (file creation or directory creation), the namespace replication section 13 registers a created file or directory if it has not been registered in the namespace replication DB 15 and ignores this event data as “information acquisition completion state” if registered. In the case where there exists an entry that satisfies the following all conditions, the corresponding file or directory is regarded as being registered.

dbe. inode#==event inode#

dbe. m_inode#==event. m_inode#

dbe. fname==event. fname

The content set at the time when the target file or directory has not been registered is shown below.

dbe. m_inode#=event. m_inode#

dbe. ftype=event. ftype

dbe. fname=event. fname

dbe. inode#=event. inode#

dbe. archive=off

dbe. migrate=off

dbe. atime event. time

dbe.active on

In the case where the event data represents the file name change (event. rectype==rename) type operation, the namespace replication section 13 processes this event in the following procedure. In the case where a file or directory having the same name as one obtained after rename processing has been registered (evaluated by file name and parent inode number), the namespace replication section 13 deletes the corresponding entry from the namespace replication DB 15. In the case where there exists an entry that satisfies the following all conditions, the corresponding file or directory is regarded as being registered.

dbe. name==event. target. fname

dbe. m_inode#==event. target. m_inode#

dbe. fname==event. target. fname

In the case where a target file has been registered in the namespace replication DB 15, the namespace replication section 13 changes the parent information and file name of the corresponding entry. In the case where there exists an entry that satisfies the following all conditions, the corresponding file is regarded as being registered.

dbe. inode#==event. inode#

dbe. m_inode#==event. m_inode#

dbe. fname==event. fname

The content to be changed at this time is shown below.

dbe. m_inode#=event. target. m_inode#

dbe. name=event. target. fname

In the case where a target file has not been registered in the namespace replication DB 15, the namespace replication section 13 registers a renamed file in the namespace replication DB 15 as a new entry.

dbe. inode#=event. inode#

dbe. m_inode#=event. target. m_inode#

dbe. name=event.target.fname

dbe. active=off

In the case where the event data represents the file access (event. rectype==access), the namespace replication section 13 ignores this event data if the target inode has not been registered. Otherwise, the namespace replication section 13 updates (since there exist “hard links”) the file access last time, archive information, and recall information of all registered entries. In the case where there exists an entry that satisfies the following all conditions, the corresponding inode is regarded as being registered.

dbe. inode#==event. inode#

The content to be changed at this time is shown below.

dbe. atime event. time

In the case where the event data represents the archive state change (event. rectype==archive), the namespace replication section 13 ignores this event data if the target inode has not been registered. Otherwise, the namespace replication section 13 updates (since there exist “hard links”) the archive information of all registered entries. In the case where there exists an entry that satisfies the following all conditions, the corresponding inode is regarded as being registered.

dbe. inode#==event. inode#

The content to be changed at this time is shown below.

dbe. archive event. archive

dbe. migrate=event. migrate

Then, the namespace replication section 13 registers the content of the file information in the namespace replication DB 15 if it not registered therein as “information acquisition completion state” (S305). In the case where there registered the tuples having the same inode number, the namespace replication section 13 changes the content of all the registered entries. In the case where there exists an entry that satisfies the following all conditions, the corresponding file information is regarded as being registered.

dbe. inode#==fstat. inode#

dbe. fname==fstat. fname

dbe. m_inode#==fstat. m_inode#

The content of a new entry set, in the case where there exists no corresponding entry, is shown below.

dbe. m_inode#=fstat. m_inode#

dbe. ftype=fstat. ftype

dbe. fname=fstat. fname

dbe. inode#=fstat. inode#

dbe. archive=fstat. archive

dbe. migrate=fstat. migrate

dbe. atime=fstat. atime

dbe. active=on

The content set in the case where the same inode number has been registered (i.e., dbe. inode#=fstat. inode#) is shown below.

dbe. archive=fstat. archive

dbe. migrate=fstat. migrate

dbe. atime=fstat. atime

dbe. active=on

When processing of all recorded file information has been completed, the namespace replication section 13 determines whether any segment (directory whose information has not been acquired) of the namespace that has been missed in the information acquisition processing due to processing conflict with the file operation that changes the namespace exists or not (S311). When determining that there is no directory whose information has not been acquired (N in S311), the namespace replication section 13 ends this flow. On the other hand, when determining that any directory whose information has not been acquired exists (Y in S311), the namespace replication section 13 performs the file information acquisition processing with the relevant directory set as a root, reflects events data that has occurred during the above file information acquisition processing on the acquired file information events (S312) and returns to step S311, where the namespace replication section 13 repeats the above processing for another directory whose information has not been acquired.

The namespace-following processing will next be described.

The namespace-following section 14 receives event data generated after completion of the namespace replication processing from the event data recording section 21 and sequentially reflects the event data on the namespace replication DB 15. The event data reflection processing is almost the same as the namespace replication processing except that it does not use file information and, therefore, becomes correspondingly simpler than the namespace replication processing.

In the case where the event data represents the file delete type operation event (file delete or directory delete), the namespace-following section 14 deletes the entry including all of the inode number, parent inode number, and file name indicated by the event data from the namespace replication DB 15.

In the case where the event data represents the file creation type operation (file creation or directory creation), the namespace-following section 14 registers the entry including the inode number indicated by the event data in the namespace replication DB 15 and sets the attribute (type) and parent inode number notified by the event data.

In the case where the event data represents the file name change (rename) type operation, when a file having the same name as a target one, the namespace-following section 14 deletes it. Further, the namespace-following section 14 changes the parent attribute of the source.

In the case where the event data represents the file access event, the namespace-following section 14 identifies the access time notified by the event data with the inode number and sets it in the namespace replication DB 15.

In the case where the event data represents the archive state change, the namespace-following section 14 updates the archive information.

The migration processing will next be described.

The migration determination section 16 uses a command or the like provided by the file system to periodically check the available amount of free space in the primary storage 1. When the available amount of free space becomes less than the value specified by a user, the migration determination section 16 uses the information set in the namespace replication DB 15 to determine a migration target file and requires the file system controller 12 to perform migration processing. At this time, the migration determination section 16 delivers the path name of a file obtained from the namespace replication DB 15 to the file system controller 12 so that the file system controller 12 writes the path name and corresponding file data in the secondary storage 2. The migrate determination processing can be performed in various manner according to a user policy, and the following is an example thereof.

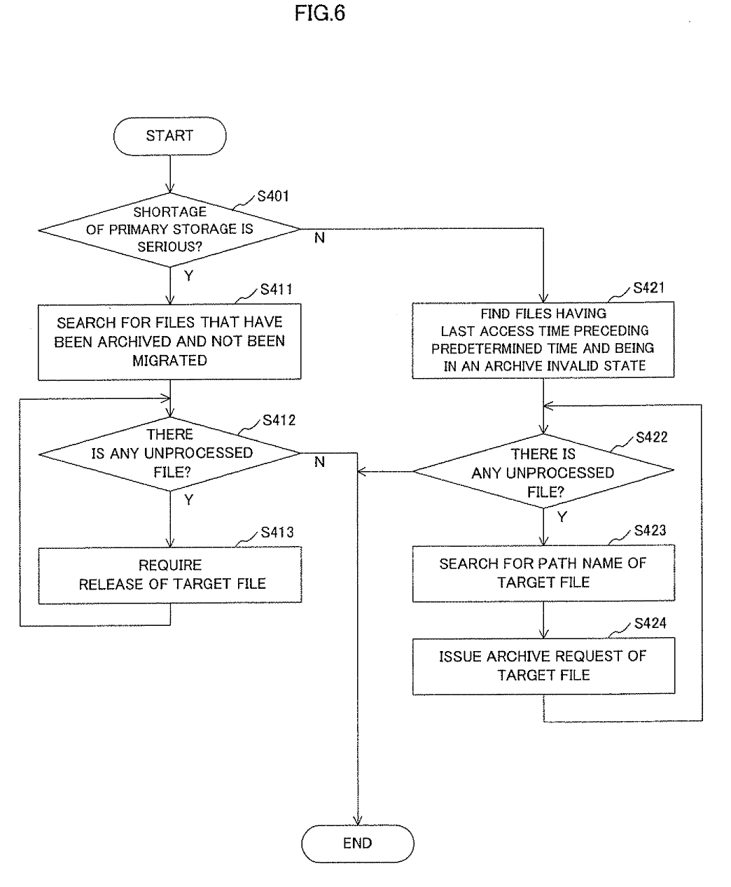

FIG. 6 is a flowchart showing an example of operation of the migration determination processing according to the present invention. The migration determination section 16 determines whether shortage of the primary storage 1 is serious or not (S401).

In the case where shortage of the primary storage 1 is serious (Y in S401), the migration determination section 16 searches the namespace replication DB 15 to find files that have been archived and not been migrated (S411) and performs the following release processing (release of the primary storage area) for all the found files. Then, the migration determination section 16 determines whether there is any unprocessed file among the found files (S412).

In the case where there is no unprocessed file (N in S412), the migration determination section 16 ends this flow. On the other hand, in the case where there is any unprocessed file (Y in S412), the migration determination section 16 requires the file system controller 12 to perform release of the primary storage, i.e., release the target file using the inode number set in the namespace replication DB 15 as an argument (S413). Then, upon receipt of a reply from the file system controller 12, the migration determination section 16 returns to step S412, where it performs processing for the next file.

Since the namespace replication DB 15 lags behind the file system, there may be case where a target file has actually been modified, that is archive state in the namespace replication DB 15 has been invalid, and respond to the migration determination section 16. In such a case, the file system controller 12 returns an error reply. In the case where a target file has been in an archived state, the file system controller 12 releases the primary storage area that has been allocated for storing the file and returns a normal reply.

On the other hand, in the case where the shortage of the primary storage 1 is not serious (N in S401), the migration determination section 16 archives files that have not been accessed for a given time period so as to immediately cope with a serious shortage, if it occurs. To this end, the migration determination section 16 searches the namespace replication DB 15 so as to find files having the last access time preceding a predetermined time (e.g., current time minus one day) and being in an archive invalid state (files that have not been archived) (S421). Subsequently, the migration determination section 16 determines whether there is any unprocessed file in the found files (S422).

In the case where there is no unprocessed file (N in S422), the migration determination section 16 ends this flow. On the other hand, in the case where there is any unprocessed file (Y in S422), the migration determination section 16 uses the parent inode number set in the namespace replication DB 15 as a key to repeatedly search the namespace replication DB 15 to find the path names of the unprocessed files (S423). Then, the migration determination section 16 issues an archive request together with the inode number and file path name as arguments to the file system controller 12 (S424). Upon reception of the request, the file system controller 12 collectively writes the data, file path name, and inode number of a specified file on the secondary storage and returns to step S422 where it performs processing for the next target file. If, in step S424, the requested file no longer exists, the file system controller 12 returns an error reply to the migration determination section 16 and ignores the request.

A description will be made of operation of the other sections.

First, operation of the file system controller 12 will be described.

When receiving a release request from the migration determination section 16, the file system controller 12 performs the release request and, if copies of target file data exist (have been archived) in the secondary storage, releases the primary storage, thereby setting the target files in a migrated state. At this time, the event data recording section 21 creates an archive state change event as follows.

event. rectype=archive

event. archive=on

event. migrate=on

When receiving a archive request from the migration determination section 16, the file system controller 12 performs the release request, starts writing file data on the secondary storage 2, and returns processing control to the migration determination section 16. At this writing time, the file system controller 12 adds the file path name notified from the migration determination section 16 to the header section of the data to be written. After the completion of the writing to the secondary storage 2, the event data recording section 21 creates an archive state change event as follows.

event. rectype=archive

event. archive=on

event. migrate=off

In the case where the application section 11 tries to access the migrated file, the file system controller 12 allocates a new area on the primary storage 1 at that timing when the application section 11 tries to access the migrated file and reads the target data on the secondary storage 2 in that area. After that the event data recording section 21 creates an archive state change event representing completion of the recall as follows.

event. rectype=archive

event. archive=on

event. migrate=off

In the case where the application section 11 requests file operation (file creation/delete, directory creation/delete, file read/write), the file system controller 12 processes the request After the file system controller 12 has normally processed the request, the event data recording section 21 creates a corresponding event data.

In the case where the file information is required from the namespace replication section 13 using getinfo, the file system controller 12 confirms that the specified file exists in the parent directory and returns the file information of the specified file. If the specified file does not exist, the file system controller 12 returns an error reply. When receiving the error reply, the namespace replication section 13 determines that the specified file has not existed and shifts to the subsequent processing.

Operation of the event data recording section 21 will next be described.

The event data recording section 21 exists in the file system controller 12 and has a function of creating event data at the timing described in the explanation for the operation of the file system controller 12 and stores it in a memory. Further, the event data recording section 21 collectively notifies the namespace-following section 14 or namespace replication section 13 of the event data stored in a memory when the amount of the event data on the memory becomes greater than a certain value or after a certain time period has elapsed from the previous notification. Further, also when the system is normally terminated, the event data recording section 21 performs system termination processing to notify the namespace-following section 14 of the event data stored therein to thereby allow the namespace-following section 14 to reflect all the event data on the namespace replication DB 15.

Further, in order to reduce the amount of data to be notified, the event data recording section 21 performs optimization as follows. In the case where the event data recording section 21 creates a file access event, when a file access event for the same file is included in unnotified event data on the memory, the event data recording section 21 discards the succeeding file access events, that is, does not store them in the memory. In the case where the event data recording section 21 is required to create a file delete event when a corresponding file creation event is included as unnotified event data, the event data recording section 21 invalidates the file creation event on the memory to exclude it from the object to be notified.

Next, system start-up processing in the server 3 will be described.

When the system is normally terminated, the namespace-following section 14 performs normal termination processing to collectively reflect the event data on the memory on the namespace replication DB 15 as described above, so that it is not necessary to make the namespace replication section 13 work at the next start-up time. On the other hand, in the case where any failure has occurred, the namespace replication section 13 is activated to perform start-up processing after system abnormal termination to resynchronize the namespace replication DB 15 with the actual name space in the primary storage. Since the namespace information immediately before the failure remains even in such a case, when a migration target needs to be determined until the re-initialization of the namespace replication is completed, the migration determination section can continue processing using the data stored in the namespace replication DB 15.

Although the migration determination section 16 performs the policy control based on the namespace replication DB 15 in the present embodiment, another configuration of a policy control in the HSM control may be performed based on the namespace replication DB 15.

Further, it is possible to provide a program that allows a computer constituting the HSM control apparatus to execute the above steps as an HSM control program. By storing the above program in a computer-readable storage medium, it is possible to allow the computer constituting the HSM control apparatus to execute the program. The computer-readable medium mentioned here includes: an internal storage device mounted in a computer, such as ROM or RAM, a portable storage medium such as a CD-ROM, a flexible disk, a DVD disk, a magneto-optical disk, or an IC card; a database that holds computer program; another computer and database thereof; and a transmission medium on a network line.

A file migration instruction section corresponds to the migration determination section in the embodiment. An event data recording step corresponds to the processing performed by the event data recording section in the embodiment. A namespace replication step corresponds to the name space replication processing in the embodiment. A namespaces-following step corresponds to the namespace-following processing in the embodiment. A file migration instruction step corresponds to the processing performed by the migration determination section in the embodiment. A system termination step corresponds to the system termination processing in the embodiment. A start-up step after system abnormal termination corresponds to the start-up processing after system abnormal termination in the embodiment.

### INDUSTRIAL APPLICABILITY

As described above, the present invention allows the namespace to follow the namespace replication DB with less work load even while an application program is running as long as the namespace replication DB is once generated, thereby enhancing the performance of the entire HSM apparatus. Further, creation and use of the namespace replication DB allows a complicated policy control to be performed based on a consistent namespace in a separated manner from the operation of the file system. Further, it is not necessary to make the event data nonvolatile at the occurrence time of the event but only necessary to store the event data in a small capacity memory, thereby reducing overhead involving the subsequent namespace replication DB-following processing.

1. An HSM program allowing a computer to execute control for an HSM apparatus using primary and secondary storages, the program allowing the computer to execute:
an event data recording step that records a file operation for the primary storage or archive state change as event data;
a namespace replication step that generates a namespace replication database obtained by replicating the namespace of the primary storage;
a namespace-following step that allows the namespace replication database to follow the namespace of the primary storage based on the event data; and
a file migration instruction step that instructs file migration between the primary and secondary storages based on the namespace replication database.

2. The HSM control program according to claim 1, wherein
the file migration instruction step determines a file to be migrated from the primary storage to secondary storage based on the namespace replication database.

3. The HSM control program according to claim 1, wherein
the namespace-following step updates the namespace replication database based on event data existing after completion of the initial replication of the namespace replication database.

4. The HSM control program according to claim 1, wherein
the namespace replication step updates the namespace replication database based on event data existing during generation of the namespace replication database.

5. The HSM control program according to claim 1, wherein
in the case where a system in which the HSM control program is running is terminated, the program further allows the computer to execute a system termination step that reflects event data recorded by the event data recording step on the namespace replication database.

6. The HSM control program according to claim 1, wherein
in the case where a system in which the HSM control program is running is started up after abnormal termination of the system, the program further allows the computer to execute the namespace replication step.

7. The HSM control program according to claim 1, wherein
in the case where the amount of recorded event data reaches a predetermined value or after a predetermined time period has elapsed, the event recording data step allows the namespace-following step to be executed based on the recorded event data.

8. The HSM control program according to claim 1, wherein
the event data includes the type and occurrence time of a file operation or archive state change.

9. The HSM control program according to claim 1, wherein
the namespace replication database includes a file attribute and archive state.

10. An HSM control apparatus that executes control for an HSM apparatus using primary and secondary storages, comprising:
an event data recording section that records a file operation for the primary storage or archive state change as event data;
a namespace replication section that generates a namespace replication database obtained by replicating the namespace of the primary storage;
a namespace-following section that allows the namespace replication database to follow the namespace of the primary storage based on the event data; and
a file migration instruction section that instructs file migration between the primary and secondary storages based on the namespace replication database.

11. The HSM control apparatus according to claim 10, wherein
the file migration instruction section determines a file to be migrated from the primary storage to secondary storage based on the namespace replication database.

12. The HSM control apparatus according to claim 10, wherein
the namespace-following section updates the namespace replication database based on event data existing after completion of the initial replication of the namespace replication database.

13. The HSM control apparatus according to claim 10, wherein
the namespace replication section updates the namespace replication database based on event data existing during generation of the namespace replication database.

14. The HSM control apparatus according to claim 10, wherein
in the case where a system provided with the HSM control apparatus is terminated, the event data recording section reflects recorded event data on the namespace replication database.

15. The HSM control apparatus according to claim 10, wherein
in the case where a system provided with the HSM control apparatus is started up after abnormal termination of the system, the namespace replication section is activated.

16. The HSM control apparatus according to claim 10, wherein
in the case where the amount of recorded event data reaches a predetermined value or after a predetermined time period has elapsed, the operation of the namespace-following section is executed based on the recorded event data.

17. The HSM control apparatus according to claim 10, wherein
the event data includes the type and occurrence time of a file operation or archive state change.

18. The HSM control apparatus according to claim 10, wherein
the namespace replication database includes a file attribute and archive state.

19. An HSM control method that executes control for an HSM apparatus using primary and secondary storages, comprising:
an event data recording step that records a file operation for the primary storage or archive state change as event data;
a namespace replication step that generates a namespace replication database obtained by replicating the namespace of the primary storage;
a namespace-following step that allows the namespace replication database to follow the namespace of the primary storage based on the event data; and
a file migration instruction step that instructs file migration between the primary and secondary storages based on the namespace replication database.

20. The HSM control method according to claim 19, wherein
the file migration instruction step determines a file to be migrated from the primary storage to secondary storage based on the namespace replication database.
